(19) United States
(12) Patent Application Publication
(10) Pub. No.: US 2007/0245274 A1
(43) Pub. Date: Oct. 18, 2007

(54) INTEGRATED CIRCUIT DESIGN APPARATUS AND METHOD THEREOF

(75) Inventor: Tomohisa Kimura, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/733,946

(22) Filed: Apr. 11, 2007

(30) Foreign Application Priority Data
Apr. 12, 2006 (JP) 2006-110133

(51) Int. Cl. G06F 17/50

(52) U.S. Cl. 716/4

(57) ABSTRACT

An integrated circuit apparatus according to an aspect of the present invention includes: an input portion for inputting information on a physical form relating to a wiring and an element which are desired out of first schematic data as physical form information on the wiring and the element; a schematic data generating portion for generating a wiring symbol and an element symbol including the physical form information based on the physical form information inputted by the input portion and thereby generating second schematic data having the wiring symbol and the element symbol correspondingly to a mask pattern; and a circuit simulation portion for executing a circuit simulation by using the second schematic data.

### CROSS REFERENCE TO RELATED APPLICATIONS

This application is based upon and claims benefit of priority under 35 USC 119 from the Japanese Patent Application No. 2006-110133, filed on Apr. 12, 2006, the entire contents of which are incorporated herein by reference.

### BACKGROUND OF THE INVENTION

The present invention relates to an integrated circuit design apparatus and a method thereof.

An integrated circuit is designed by sequentially executing circuit design for designing a schematic, layout design for designing a mask pattern (layout pattern) based on the schematic and layout design verification. Thereafter, a mask is generated by using an acquired mask pattern.

The layout design verification includes a design rule check (DRC) for verifying whether or not the mask pattern is in accordance with a design rule and a layout versus schematic (LVS) for comparing the schematic with the mask pattern for instance.

After manufacturing the integrated circuit, parasitic elements such as a parasitic resistance, a parasitic capacitance and a parasitic inductance are formed to a wiring for connecting each of the elements in the integrated circuit. The parasitic elements exert various kinds of influence on operation of the integrated circuit, and there are also the cases where they cause a malfunction of the integrated circuit.

For this reason, there is a proposed method of executing a circuit simulation considering the influence of the parasitic elements when performing the circuit simulation for predicting an actual operating state in a stage of the circuit design. As for such a method, there is a method, for instance, of calculating a resistance value of the parasitic resistance and a capacitance value of the parasitic capacitance out of the parasitic elements formed on the wiring based on inputted circuit information and adding them to the circuit information so as to execute the circuit simulation (refer o Japanese Patent Laid-Open No. 10-3489 for instance).

The document title relating to the circuit simulation is listed below.

### SUMMARY OF THE INVENTION

An integrated circuit design apparatus according to an aspect of the present invention includes:

an input portion for inputting information on a physical form relating to a desired wiring out of first schematic data as physical form information on the wiring;

a schematic data generating portion for generating a wiring symbol including the physical form information based on the physical form information inputted by the input portion and thereby generating second schematic data having the wiring symbol correspondingly to a mask pattern; and

a circuit simulation portion for executing a circuit simulation by using the second schematic data.

An integrated circuit design apparatus according to another aspect of the present invention includes:

an input portion for inputting information on a physical form relating to a desired element out of first schematic data as physical form information on the element;

a schematic data generating portion for generating an element symbol including the physical form information based on the physical form information inputted by the input portion and thereby generating second schematic data having the element symbol correspondingly to a mask pattern; and

a circuit simulation portion for executing a circuit simulation by using the second schematic data.

### BRIEF DESCRIPTION OF THE DRAWINGS

FIG. 1 is a block diagram showing a configuration of an integrated circuit design apparatus according to an embodiment of the present invention;

FIG. 2 is an explanatory diagram showing an example of schematic data;

FIG. 3 is an explanatory diagram showing an example of the schematic data formed by wiring symbols having physical form information;

FIGS. 4 are explanatory diagrams showing examples of wiring models;

FIG. 5 is an explanatory diagram showing an example of the wiring model in which a branch exists;

FIG. 6 is an explanatory diagram showing an example of the wiring symbol which is formed to intersect;

FIG. 7 is an explanatory diagram showing an example of the schematic data;

FIG. 8 is an explanatory diagram showing an example of the schematic data formed by element symbols including the physical form information;

FIG. 9 is an explanatory diagram showing an example of a mask pattern;

FIGS. 10 are explanatory diagrams showing examples of the element symbol and a mask pattern of an inductor;

FIG. 11 is an explanatory diagram showing an example in the case where a ground wiring is formed as the wiring symbol;

FIG. 12 is an explanatory diagram showing an example of the schematic data displayed on a display portion;

FIG. 13 is an explanatory diagram showing an example of the mask pattern displayed on the display portion; and

FIG. 14 is an explanatory diagram showing an example of the schematic data formed by the element symbols including the physical form information and displayed on the display portion.

### DETAILED DESCRIPTION OF THE INVENTION

Hereunder, an embodiment of the present invention will be described with reference to the drawings.

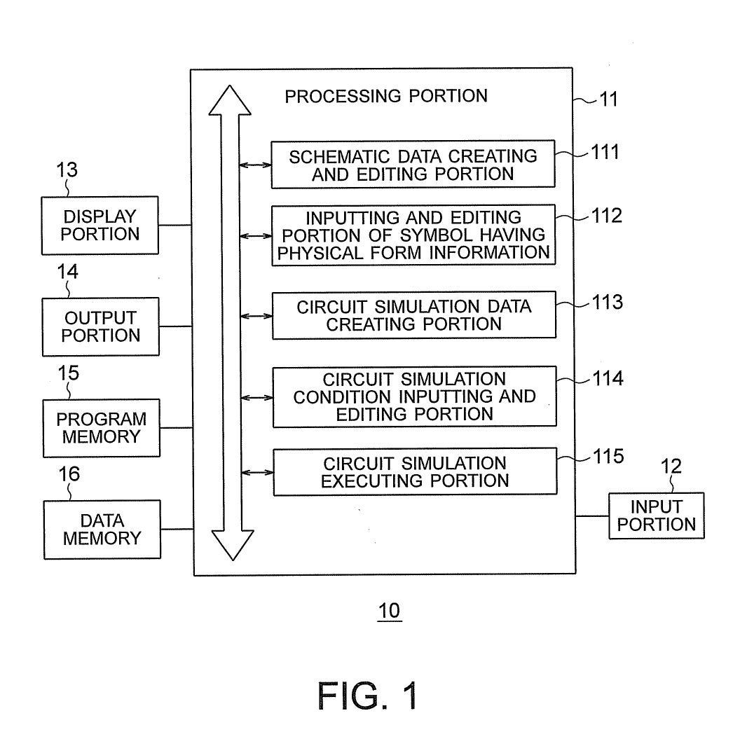

FIG. 1 shows a configuration of an integrated circuit design apparatus 10 according to an embodiment of the present invention. A processing portion 11 is composed of blocks having the following functions. A schematic data creating and editing portion 111 (schematic data generating portion) creates and edits a schematic for executing a circuit simulation. An inputting and editing portion 112 of a symbol having physical form information inputs and edits attributes of an element symbol having a path and a size of which influence from parasitics should be considered.

A circuit simulation data creating portion 113 creates circuit simulation input data (netlist) from circuit information created by the schematic data creating and editing portion 111. A circuit simulation condition inputting and editing portion 114 inputs and edits an analysis condition and a circuit condition required to perform an analysis in a circuit simulation executing portion 115. The circuit simulation executing portion 115 (circuit simulation portion) executes the circuit simulation.

An input portion 12 inputs necessary information by using a keyboard and a mouse. A display portion 13 displays schematic data, circuit simulation conditions and circuit simulation results on a display. An output portion 14 outputs information on the schematic data and the circuit simulation results to an external apparatus via a network. A program memory 15 holds numeric calculation data when executing the circuit simulation. A data memory 16 holds necessary information for the circuit simulation such as a circuit symbol, process data and a model parameter and analysis results circuit simulation conditions and circuit simulation parameters.

Here, concrete description will be given as to the case of generating a wiring symbol by using the integrated circuit design apparatus 10. In this case, the data memory 16 prepares a wiring symbol having the physical form information and a wiring symbol having no physical form information as kinds of wiring symbols. If an operator selects one of the two kinds of wiring symbols, the schematic data creating and editing portion 111 generates the selected kind of wiring symbol by reading necessary data from the data memory 16.

The data memory 16 prepares a wiring layer, a wiring width, a wiring length, a wiring model, a frequency of a signal for transmitting the wiring, a wiring position and the like as the physical form information of the wiring symbol. Thus, in the case where the wiring symbol having the physical form information is selected as the kind of wiring symbol and desired physical form information is inputted, the schematic data creating and editing portion 111 generates the wiring symbol having the physical form information by reading necessary data from the data memory 16.

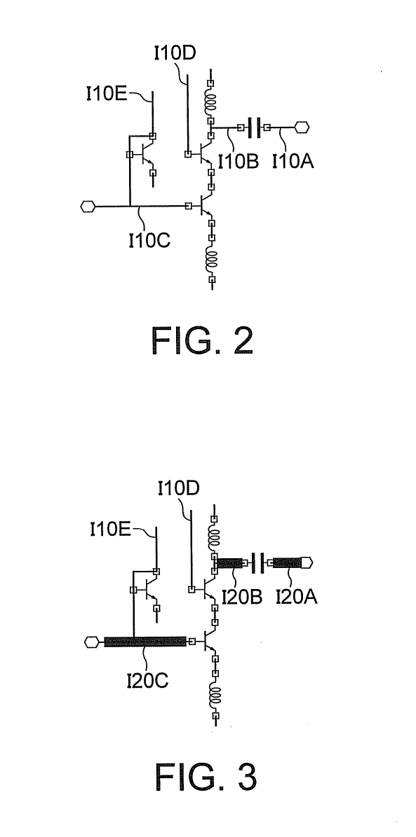

For instance, of wiring symbols 110A to 110E, the schematic data creating and editing portion 111 selects the wiring symbols 110A to 110C as the wiring symbols having the physical form information and selects the wiring symbols 110D and 110E as the wiring symbol having no physical form information on the schematic data shown in FIG. 2 according to the operator's input operation.

Subsequently, if the physical form information on each of the wiring symbols 110A to 110C is inputted, the schematic data creating and editing portion 111 generates wiring symbols 120A to 120C having the inputted physical form information as shown in FIG. 3.

Of the physical form information on the wiring symbols, a kind of wiring layer is inputted as to the wiring layer, such as a first layer, a second layer or a stacked structure of second and third layers. As for the wiring width, the wiring width of a mask pattern generated later is inputted. As for the wiring length, the length of a straight-line portion (segment) of the wiring is inputted.

A so-called stack wiring having multiple wiring layers stacked can also be handled likewise. It is represented as a pattern having patterns of multiple layers superimposed therein on the schematic. In the case where a VIA pattern is placed between the wiring layers, a pattern according to it is prepared. It helps a designer understand, in either case, if it looks like the stack wiring of layout pattern data. In the case of the stack wiring, it is desirable in terms of accuracy to use a value of resistivity or a process parameter of a capacitance value per unit area if such a value is known. In the case where there is no such value, it is considered that multiple wirings are connected in parallel.

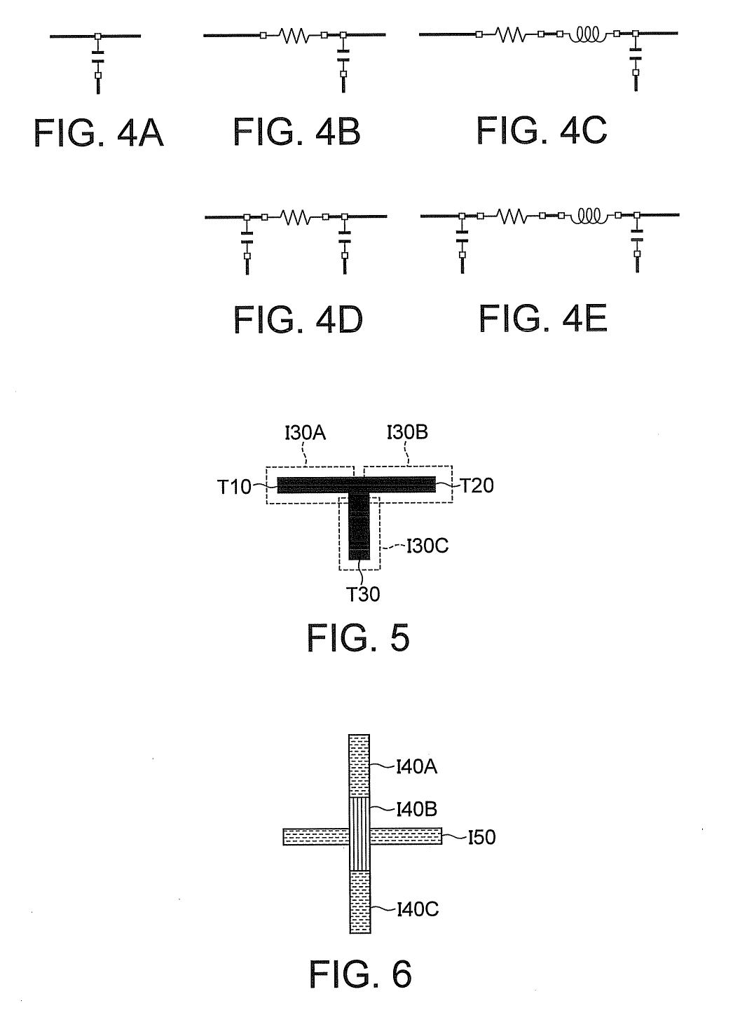

As shown in FIGS. 4 for instance, the wiring model is selected out of a wiring model formed by a parasitic capacitance (FIG. 4A), a wiring model formed by a parasitic resistance and a parasitic capacitance (FIGS. 4B and D) and a wiring model formed by a parasitic resistance, a parasitic capacitance and a parasitic inductance (FIGS. 4C and E). It is also possible to select a form out of L-type forms (FIGS. 4A to 4C), π-type forms (FIGS. 4E and 4D) and the like and the number of stages thereof.

As shown in FIG. 5, in the case where a branch exists in the wiring symbol, the schematic data creating and editing portion 111 divides the wiring symbol into multiple straight-line portions 130A to 130C and generates the physical form information on each of the divided multiple straight-line portions 130A to 130C.

Therefore, in the case where wiring symbols 140 and 150 are formed to intersect by having straight-line portions 140A and 140C of the wiring symbol 140 formed in a first layer, a straight-line portion 140B formed in a second layer and the wiring symbol 150 formed in the first layer as shown in FIG. 6 for instance, the wiring symbol 140 is divided into the straight-line portions 140A and 140C formed in the first layer and the straight-line portion 140B formed in the second layer so as to input the kind of wiring layer as to each of the divided straight-line portions.

In this case, if the physical form information on the wiring symbol such as the kind of wiring layer is inputted, the schematic data creating and editing portion 111 selects a color and a pattern of the wiring symbol on the schematic data correspondingly to a mask pattern which is generated later, and displays them on a monitor (not shown). Thus, it becomes possible to perform outline layout design (floor plan) on the schematic data.

As shown in FIG. 5, it is also possible to process a wiring model of the wiring symbol in which a branch exists as a multi-terminal network model of which terminals are ends T10 to T30 of the wiring symbol. Input-output characteristics of a signal in the multi-terminal network model are represented by using a circuit matrix of an S parameter, a Y parameter and the like. To generate the circuit matrix, it is necessary to generate a library (database) in advance by executing processing such as performing an electromagnetic analysis of the multi-terminal network model and inputting signals to the multi-terminal network model and collecting measurement results thereof.

Element values of parasitic elements such as a resistance value of the parasitic resistance, a capacitance value of the parasitic capacitance and an inductance value of a parasitic inductance are calculated based on numeric data which is preset according to various conditions in a manufacturing process of the integrated circuit to be manufactured.

Such numeric data includes the resistivity of the wiring layer, permittivity of an insulating film and the resistance value or capacitance value per unit area for instance. An inductance value L is calculated by the following formula for instance.
L=2I{In[2I/(w+t)]+0.50049+(w+t)/3I} [Formula 1]
Here, I denotes the wiring length, w denotes the wiring width, and t denotes a wiring thickness. As the element values of the parasitic elements change due to a skin effect for instance, they are corrected according to the frequency of the signal for transmitting the wiring.

Thus, if the wiring symbol is generated by using the integrated circuit design apparatus 10 according to this embodiment, it is possible to execute the circuit simulation considering the influence of the parasitic elements on the schematic data. As no parasitic element is inserted into the wiring symbol on the schematic data, it is possible to avoid detection of an error caused by the inserted parasitic element in layout design verification when performing a layout versus schematic (LVS) for comparing the schematic data with the mask pattern.

Subsequently, a concrete description will be given as to the case of generating the element symbol by using the integrated circuit design apparatus 10. In this case, the data memory 16 prepares the kind of element, parameter of the element, position of the element on a semiconductor substrate, various structures formed on the semiconductor substrate (such as a well region, electrodes and a guard ring (junction protection structure)) and the like as the physical form information on the element symbol.

Thus, if the desired physical form information on the element is inputted, the schematic data creating and editing portion 111 generates the element symbol having the physical form information by reading the necessary data from the data memory 16. To be more specific, if the resistance, capacitor, inductor, transistor or the like is inputted as the kind of element, and if the resistance value, capacitance value, an inductance value, transistor dimensions or the like is inputted as the parameter of the element out of the physical form information, the schematic data creating and editing portion 111 generates the element symbol of a size according to the inputted physical form information.

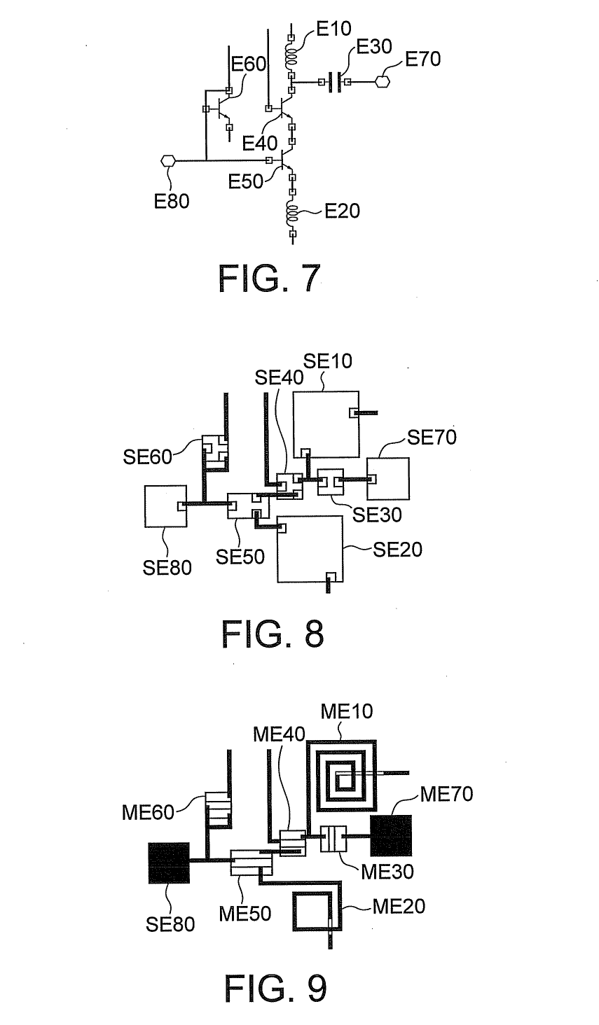

For instance, if the physical form information is inputted to each of the elements of an inductors E10 and E20, a capacitor E30, transistors E40 to E60 and pads E70 and E80 on the schematic data shown in FIG. 7 according to the operator's input operation, the schematic data creating and editing portion 111 generates the element symbols SE10 to SE80 having the physical form information correspondingly to the elements E10 to E80 as shown in FIG. 8.

The element symbols SE10 to SE80 in the schematic data (FIG. 8) are generated to be approximate and corresponding to element patterns ME10 to ME80 of the mask pattern (FIG. 9) which is generated later. Thus, if the element symbol is generated by using the integrated circuit design apparatus 10 according to this embodiment, it is possible to perform the overview layout design (floor plan) on the schematic data.

In FIG. 8, reference characters SE10 and SE20 denote the inductors, SE30 denote the capacitor, SE40, SE50 and SE60 denote the transistors, and SE70 and SE80 denote pad symbols. As for the element symbols of the inductors, capacitors, transistors, resistances and the like, the sizes of the symbols themselves change to the values approximating the sizes of actual layout patterns in conjunction with changes of the values and device dimensions. It is thereby possible to make a rough floor plan on the schematic and calculate more accurate parasitic element values.

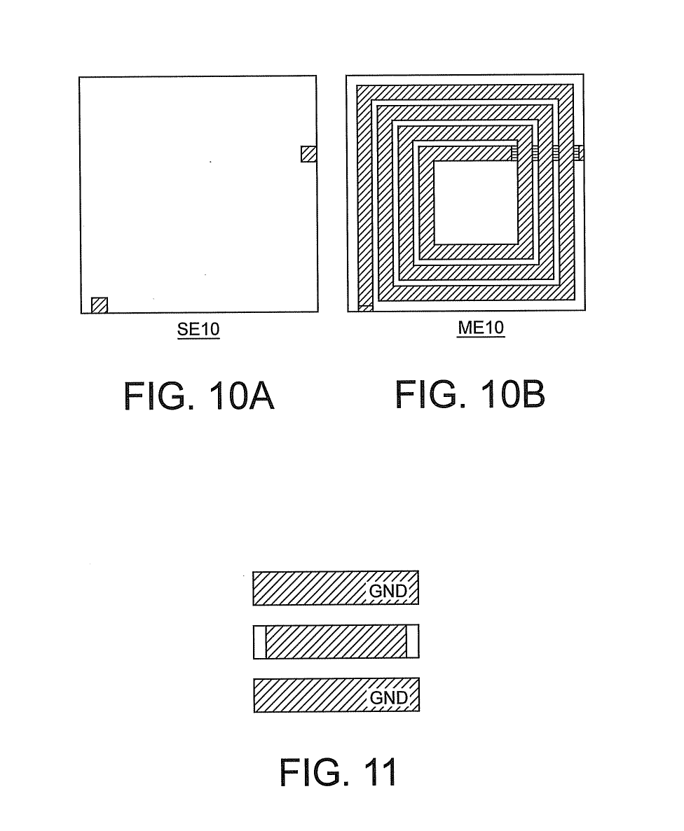

Here, FIG. 10A shows the element symbol SE10 of the inductor having the physical form information of the schematic data (FIG. 8). FIG. 10B shows an inductor pattern ME10 of the inductor of the mask pattern (FIG. 9).

As shown in FIGS. 10A and 10B, the element symbol SE10 of the inductor is formed so that positions of its terminals correspond to the positions of the terminals of the inductor pattern ME10. In addition, the wiring layers of the terminals are generated correspondingly to the color and pattern of the wiring layers of the terminals of the inductor pattern ME10.

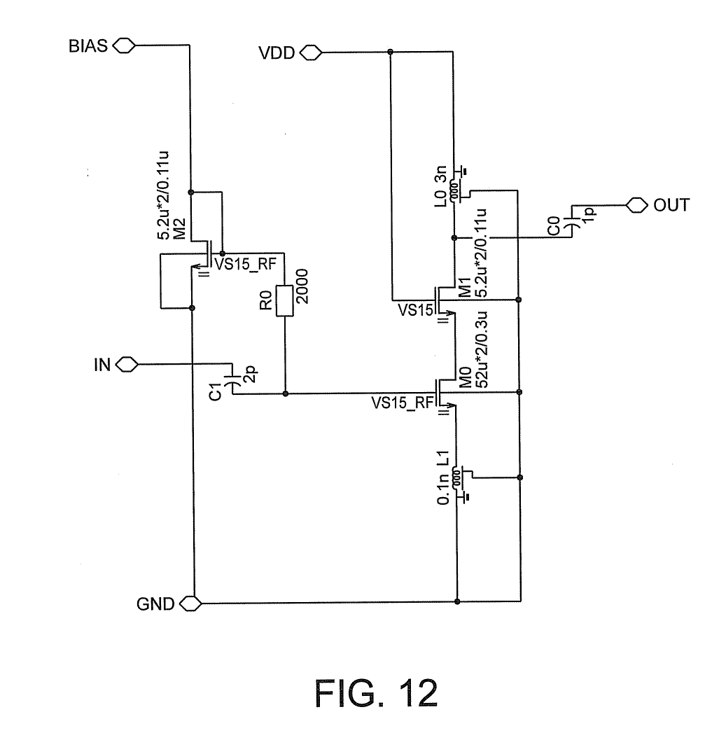

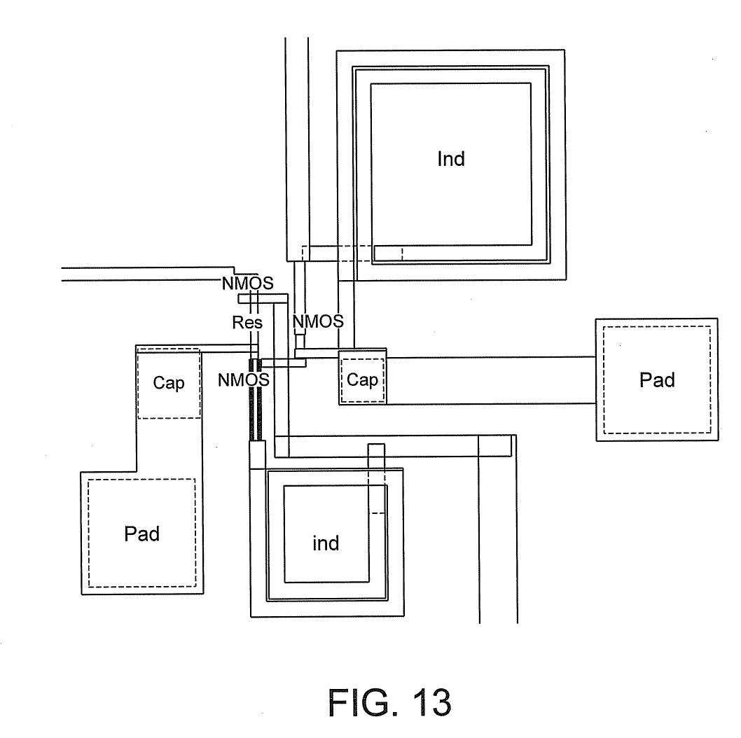

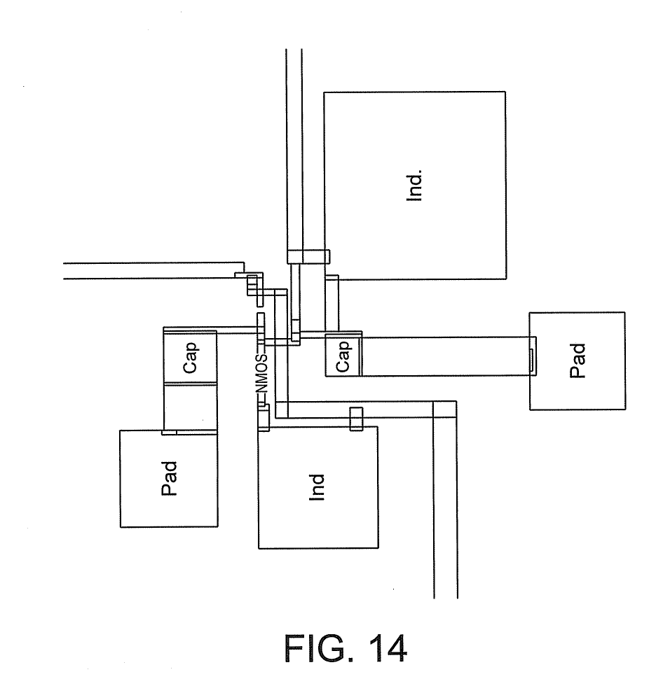

Here, FIG. 12 shows an example of the schematic data displayed in the display portion 13. FIG. 13 shows an example of the mask pattern (layout pattern) displayed in the display portion 13. FIG. 14 shows an example of the schematic data displayed in the display portion 13, which has the element symbols having the physical form information placed therein.

Thus, according to the present invention, it is possible to execute the circuit simulation considering the influence of the parasitic elements and the outline layout design on the schematic data. It is thereby possible to improve the accuracy and efficiency in the integrated circuit design.

The above-mentioned embodiment is just an example which does not limit the present invention. It is also possible, for instance, to decide the wiring width of the wiring, an interval between the wiring and a ground wiring and the like by selecting and inputting a characteristic impedance (parasitic resistance value) of the wiring of 50 Ω for instance as the physical form information on the wiring symbol. In this case, it is indicated that the wiring is the ground wiring as shown in FIG. 11 when generating the ground wiring on the schematic data.

A characteristic impedance Z (s) of a line can be represented as follows by using R (resistance value per unit length), C (capacitance value per unit length), L (inductance value per unit length) and G (loss value per unit length).
Z(s)={(R+sL)/(G+sC)}^{1/2} [Formula 2]
Here, s means a complex frequency jω. If the L component and G component are ignored in this formula, it is possible to create a line having an arbitrary characteristic impedance by optimizing the value of R and the value of C.

The value of R is selectable by selection of the wiring layer including a stack structure and the width of the wiring layer. The value of C is selectable by the selection and width of the wiring layer, existence or nonexistence of a lower-level ground wiring layer or a distance from an adjacent ground wiring. As the resistivity and capacitance value per unit area of each individual wiring layer are different process by process, it is necessary to calculate a condition for realizing, for example, a 50-Ω line by using a process parameter value in advance.

The wiring for generating the wiring symbol having the physical form information is not limited to the wiring in the integrated circuit, but may also be a wiring for connecting a bonding wire, a lead frame and a pin of a package and an integrated circuit chip mounted on a printed circuit board.

It is also possible to introduce a fluctuating parameter into the physical form information on the wiring symbol correspondingly to fluctuation of the element values of the parasitic elements formed on the wiring due to manufacturing variations. The fluctuating parameter includes a parameter for multiplying the element values of the parasitic elements by a fixed ratio (±1% for instance) or adding a fixed value (±50 nm for instance) thereto for instance.

The following is an example of how to give variations. First, there is a method of varying size information. It varies the values of a wiring film thickness and an insulating layer thickness in addition to the values of the inputted wiring width and length. Secondly, there is a method of varying the process parameter value. It varies the resistivity of the wiring, capacitance value per unit area and the value of the insulating layer thickness.

As for the methods of giving variations, there are a method of multiplying them by a coefficient of variation (giving a value which is 0.9 or 1.1 in reference to normal of 1), a method of adding an offset (adjusting an absolute amount of variation in reference to normal of 0), a method of preparing a corner model (using an upper limit and a lower limit of the resistivity or capacitance value per unit area) and a method of providing a temperature coefficient (using temperature dependence of the resistivity or capacitance value per unit area).

What is claimed is:

1. An integrated circuit design apparatus, comprising:
an input portion for inputting information on a physical form relating to a desired wiring out of first schematic data as physical form information on the wiring;
a schematic data generating portion for generating a wiring symbol including the physical form information based on the physical form information inputted by the input portion and generating second schematic data having the wiring symbol correspondingly to a mask pattern; and
a circuit simulation portion for executing a circuit simulation by using the second schematic data.

2. The integrated circuit design apparatus according to claim 1, wherein the physical form information on the wiring includes at least one of a kind of a wiring layer, a wiring width, a wiring length, a wiring position and a wiring model.

3. The integrated circuit design apparatus according to claim 1, wherein the schematic data generating portion selectively generates the wiring symbol including the physical form information and the wiring symbol not including the physical form information as the wiring symbol.

4. The integrated circuit design apparatus according to claim 2, wherein a plurality of the wiring models are prepared in advance as the wiring models and the wiring model which is desired is selected according to an operator's input operation.

5. The integrated circuit design apparatus according to claim 1, wherein the wiring symbol has the same display form as the wiring of the mask pattern corresponding to the wiring symbol.

6. The integrated circuit design apparatus according to claim 2, wherein the physical form information on the wiring symbol further includes a characteristic impedance of the wiring.

7. The integrated circuit design apparatus according to claim 2, wherein the physical form information on the wiring further includes a fluctuating parameter.

8. An integrated circuit design apparatus, comprising:
an input portion for inputting information on a physical form relating to a desired element out of first schematic data as physical form information on the element;
a schematic data generating portion for generating an element symbol including the physical form information based on the physical form information inputted by the input portion and generating second schematic data having the element symbol correspondingly to a mask pattern; and
a circuit simulation portion for executing a circuit simulation by using the second schematic data.

9. The integrated circuit design apparatus according to claim 8, wherein the physical form information on the element includes at least one of a kind of element, a parameter of the element, a position of the element and a structure of the element.

10. The integrated circuit design apparatus according to claim 8, wherein the schematic data generating portion generates the element symbol of a size according to the physical form information.

11. The integrated circuit design apparatus according to claim 8, wherein the schematic data generating portion generates the second schematic data so that a terminal position of the element symbol corresponds to the terminal position of the mask pattern.

12. The integrated circuit design apparatus according to claim 8, wherein the element symbol has the same display form as the element of the mask pattern corresponding to the element symbol.

13. An integrated circuit design method, comprising:
inputting information on a physical form relating to a desired wiring out of first schematic data as physical form information on the wiring;
generating a wiring symbol including the physical form information based on the inputted physical form information and generating second schematic data having the wiring symbol correspondingly to a mask pattern; and
executing a circuit simulation by using the second schematic data.

14. The integrated circuit design method according to claim 13, wherein the physical form information on the wiring includes at least one of a kind of a wiring layer, a wiring width, a wiring length, a wiring position and a wiring model.

15. The integrated circuit design method according to claim 13, wherein, on generating the second schematic data, it selectively generates the wiring symbol including the physical form information and the wiring symbol not including the physical form information as the wiring symbol.

16. The integrated circuit design method according to claim 14, wherein a plurality of the wiring models are prepared in advance as the wiring models and the wiring model which is desired is selected according to an operator's input operation.

17. The integrated circuit design method according to claim 13, wherein the wiring symbol has the same display form as the wiring of the mask pattern corresponding to the wiring symbol.

18. The integrated circuit design method according to claim 13, wherein the wiring symbol is represented by using a circuit matrix.

19. The integrated circuit design method according to claim 14, wherein the physical form information on the wiring symbol further includes a characteristic impedance of the wiring.

20. The integrated circuit design method according to claim 14, wherein the physical form information on the wiring further includes a fluctuating parameter.
